(19) United States
(12) Patent Application Publication
(10) Pub. No.: US 2008/0168193 A1
(43) Pub. Date: Jul. 10, 2008

(54) USE OF UNIQUE IDENTIFIERS FOR EACH DATA FORMAT SUPPORTED BY A MULTI-FORMAT DATA STORE

(75) Inventors: Allen Keith Bates, Tucson, AZ (US); Nils Haustein, Soergenloch (DE); Craig Anthony Klein, Tucson, AZ (US); Daniel James Winarski, Tucson, AZ (US)

Correspondence Address: KONRAD RAYNES & VICTOR, LLP.;ATTN: IBM37, 315 SOUTH BEVERLY DRIVE, SUITE 210, BEVERLY HILLS, CA, 90212, US

(73) Assignee: International Business Machines Corporation, Armonk, NY (US)

(21) Appl. No.: 11/621,926

(22) Filed: Jan. 10, 2007

(51) Int. Cl. G06F 3/00

(52) U.S. Cl. 710/36

(57) ABSTRACT

Provided are techniques for storing data. An Input/Output (I/O) command is received, wherein the I/O command includes a unique identifier that is associated with one region of a multi-format data store. The unique identifier is used to select an I/O channel from among multiple I/O channels, wherein each I/O channel is associated with a data format and with a region of the multi-format data store. The I/O command is forwarded to the selected I/O channel to access the region.

### BACKGROUND

1. Field

Embodiments of the invention relate to use of unique identifier for each data format supported by a multi-format data store.

2. Description of the Related Art

Some data store devices enable storage of data in multiple data formats. For example, a Blu-ray Disk (BD) is an optical disk format that is capable of storing high-definition video and data. Victor Company of Japan, Limited (also referred to as JVC) has developed a three layer technology that allows putting both standard-definition Digital Versatile Disk (DVD) data and high definition data on a BD/DVD combo disc. Since DVD disks may now store music, they are called Digital Versatile Disks, as they store more than just video. A DVD may be described as an optical disk format that can be used for data storage, including movies with video and audio.

Nonetheless, there is a need in the art for improved storage of data on a multi-format data store with the use of unique identifier for each data format supported by the multi-format data store.

### SUMMARY OF EMBODIMENTS OF THE INVENTION

Provided are a method, computer program product, and system for storing data. An Input/Output (I/O) command is received, wherein the I/O command includes a unique identifier that is associated with one region of a multi-format data store. The unique identifier is used to select an I/O channel from among multiple I/O channels, wherein each I/O channel is associated with a data format and with a region of the multi-format data store. The I/O command is forwarded to the selected I/O channel to access the region.

### BRIEF DESCRIPTION OF THE DRAWINGS

Referring now to the drawings in which like reference numbers represent corresponding parts throughout:

FIG. 1 illustrates details of a computing environment in accordance with certain embodiments.

FIG. 2 illustrates an example embodiment in accordance with certain embodiments.

FIG. 3 illustrates a table for various data formats in accordance with certain embodiments.

FIG. 4 illustrates an example write command used in accordance with certain embodiments.

FIG. 5 illustrates logic performed by a data storage drive in accordance with certain embodiments.

FIG. 6 illustrates logic performed by an I/O channel in accordance with certain embodiments.

FIG. 7 illustrates a system architecture that may be used in accordance with certain embodiments.

### DETAILED DESCRIPTION

In the following description, reference is made to the accompanying drawings which form a part hereof and which illustrate several embodiments of the invention. It is understood that other embodiments may be utilized and structural and operational changes may be made without departing from the scope of the invention.

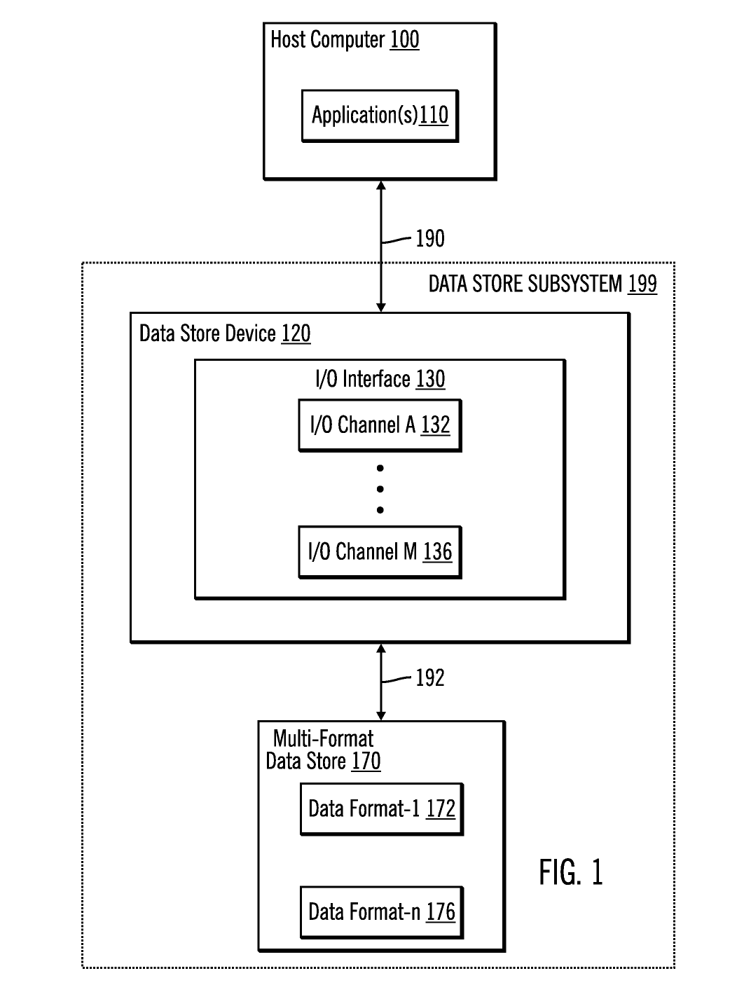

FIG. 1 illustrates details of a computing environment in accordance with certain embodiments. A host computer 100 is coupled via a communication path 190 (e.g., a network) to a data store device 120. The host computer 100 includes one or more applications 110 that may submit Input/Output (I/O) commands to the data store device 120.

A data store subsystem 199 includes the data store device 120 and a data store 170.

The data store device 120 includes an I/O interface 130. The I/O interface 130 includes two or more I/O channels 132 . . . 136. The ellipses (“ . . . ”) between I/O channel A 132 and I/O channel M 136 indicate that there may be any number (i.e., zero or more) of additional I/O channels. Each I/O channel 132 . . . 136 may be described as being capable of encoding and decoding data and is associated with one or more recording transducers, such as lasers for an optical drive. A transducer may be described as device that converts a signal from one form to another. For example, a laser write transducer converts binary digital information from the recording channel into on-off laser light pulses. Similarly, a magnetic write transducer converts binary digital information from the recording channel into North-South magnetic pulses. The data store device 120 provides the host computer 100 with access to data in a multi-format data store 170. The multi-format data store 170 may be either a data store (e.g., a hard disk drive, tape cartridge, flash memory, optical disk, VHS cartridge, DVD, etc.) or may be a data store device (e.g., a VHS recorder/player or a DVD player). The data store device 120 is coupled via a communication path 192 to the multi-format data store 170. The multi-format data store 170 is capable of storing data in different data formats in different regions, as represented by data format-1 172 and data format-n 176. The ellipses (“ . . . ”) between data format-1 172 and data format-n 176 indicate that there may be any number (i.e., zero or more) of additional I/O channels. Examples of different data formats include, for example, compact disk (CD) format, Digital Versatile Disk (DVD) format, Blu-ray format or High Definition (HD) DVD format. In certain embodiments, different regions are different depths of an optical disk.

A CD may be described as an optical disk format that is capable of storing digital data and digital audio, and digital video. An HD-DVD may be described as an optical disk format designed for high-density storage of high-definition digital video, music, and data.

The host computer 100 and data store device 120 may comprise any computing device known in the art, such as a server, mainframe, workstation, personal computer, hand held computer, laptop telephony device, network appliance, etc. The communication path 190 may comprise any type of communication path, such as a network (e.g., a peer-to-peer network, spoke and hub network), a Storage Area Network (SAN), a Local Area Network (LAN), a Wide Area Network (WAN), the Internet, an Intranet, etc.), a SCSI (small computer systems interface) bus, or a SCSI over Fibre Channel bus. The communication path 192 may comprise, for example, Eight to Fourteen Modulation (EFM) for an optical communications path, or Partial Response, Maximum Likelihood (PRML) and Run Length Limited (RLL) encoded data, or Reed-Solomon or Linear Block encoded data for either an optical or magnetic communications path.

Embodiments maximize the use of multiple data formats 172 . . . 176 supported by a multi-format data store 170. With embodiments, a unique identifier (e.g., a Logical Unit Number (LUN)) is associated with each I/O channel 132 . . . 136 and with a region of the multi-format data store 170 that stores a particular data format 172 . . . 176. Thus, the unique identifier may be described as being associated with data format 172 . . . 176. A LUN may be described as an address for an individual disk drive or disk device.

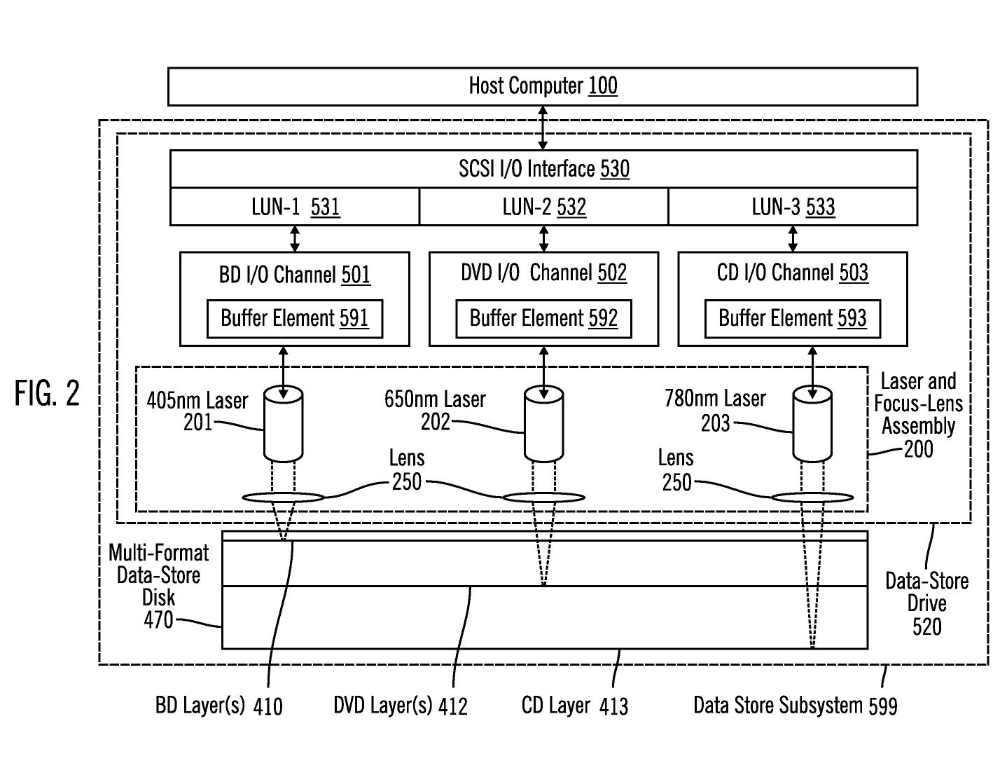

A multi-format data store 170 may be any data storage medium that is capable of storing multiple data formats (e.g., optical disk, tape cartridge, etc.), such as the multi-format data store disk 470 shown in FIG. 2.

FIG. 2 illustrates an example embodiment in accordance with certain embodiments. Host computer 100 is coupled to a data store subsystem 599. The data store subsystem 599 includes a multi-format data store disk 470 and a data store drive 520.

The multi-format data store disk 470 records data for different data formats in different layers. In certain embodiments, the multi-format data store disk 470 has up to three different recording formats for three physically separate data layers 410, 412, 413.

The data store drive 520 includes a SCSI I/O interface 530, which is coupled to LUN-1 531, LUN-2 532, and LUN-3 533. LUN-1 531 is coupled to a Blu-ray Disk (BD) I/O channel 501, which includes buffer element 591. The BD I/O channel 501 is coupled to a 405 nanometers (nm) laser 201, which is coupled to lens 250. LUN-2 532 is coupled to a DVD I/O channel 502, which includes buffer element 592. The DVD I/O channel 502 is coupled to a 650 nm laser 202, which is coupled to lens 250. LUN-3 533 is coupled to a CD I/O channel 503, which includes buffer element 593. The CD I/O channel 503 is coupled to a 780 nm laser 203, which is coupled to lens 250. The lasers 201, 202, 203 and lens 250 form a laser and focus-lens assembly 200. Lens 250 directs the lasers 201, 202, 203 to different depths of multi-format data store disk 470.

In certain embodiments, the laser and focus-lens assembly 200 is a Blu-ray drive laser assembly. The laser and focus-lens assembly 200 may be described as a single mechanical unit for seeking (i.e., moving radially across multi-format data store disk 470) with multiple optical lasers 201, 202, 203 of different wavelengths. The BD I/O channel 501 performs I/O via laser 201 for recording Blu-ray format and HD-DVD format data. The DVD I/O channel 502 performs I/O via laser 202 for recording DVD format data. The CD I/O channel 503 performs I/O via laser 203 for recording CD format data.

In the example of FIG. 2, the multi-format data store disk 470 has layers 410, 412, 413, each of which records data for a different data format and has a different depth. In particular, layer 410 records BD data. Layer 412 records DVD data. Layer 413 records CD data. Also, I/O for each data format supported by the multi-format data store disk 470 has a unique LUN address in the data store drive 520. As an example, all I/O for BD layer 410 uses LUN-1 531; all I/O for DVD layer 412 uses LUN-2 532; and all I/O for CD layer 413 uses LUN-3 533.

It is to be noted that Blu-ray and HD-DVD are not the same format, even though they both use blue lasers for higher data density. The HD-DVD layer is at the same depth as DVD layer 412. The focus lens 250 is moved perpendicular to the surface of the multi-format data store disk 470 by a focus error servo (not shown) to focus the light from respective the lasers 201, 202, and 203 onto the respective layers 410, 412, and 413 for the purpose of I/O.

I/O channels 501, 502, 503 are example embodiments of I/O channels 132 . . . 136 of FIG. 1. I/O channels may be Application Specific Integrated Circuits (ASICs) or other semiconductor chip sets.

The multi-format data store disk 470, data store drive 520, and data store subsystem 599 are specific implementations of multi-format data store 170, data store device 120, and data store subsystem 199 in FIG. 1, respectively.

Thus, embodiments provide a multi-format data store disk 470, where each specific data format has its own region of the disk 470, and each data format in each region of the disk 470 is accessed via its unique LUN. In certain embodiments, LUN-1, LUN-2, LUN-3 may be coupled to a SCSI over Fibre Channel interface, an Internet SCSI (iSCSI) interface or other interface.

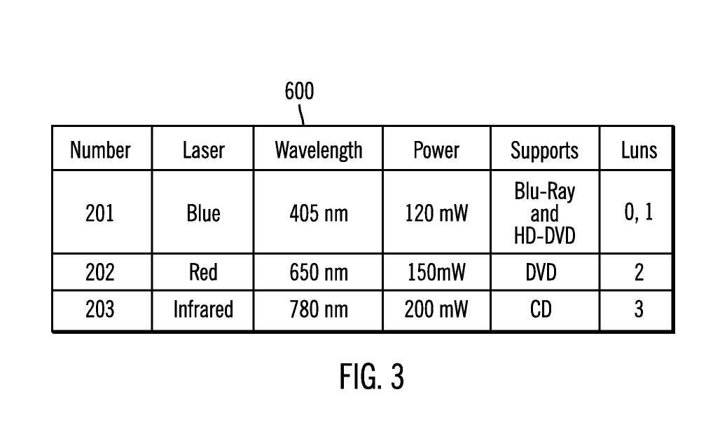

FIG. 3 illustrates Table 600 for various optical parameters in accordance with certain embodiments, such as shown in FIG. 2. In Table 600, the laser for a first I/O channel is a blue-light laser 201 with a wavelength of 405 nm and a power of 120 milliwatts (mW). The I/O channel uses the blue-light laser 201 via LUN-1 for Blu-ray I/O as shown in FIG. 2, and LUN-0 (not shown in FIG. 2) for HD-DVD I/O. The laser for a second I/O channel is a red-light laser 202 with a wavelength of 650 nm and a power of 150 mW. The I/O channel uses red-light laser 202 via LUN-2 for DVD I/O. The laser for a third I/O channel is an infrared-light laser 203 with a wavelength of 780 nm and a power of 200 mW. The I/O channel uses infrared-light laser 203 via LUN-3 for CD I/O.

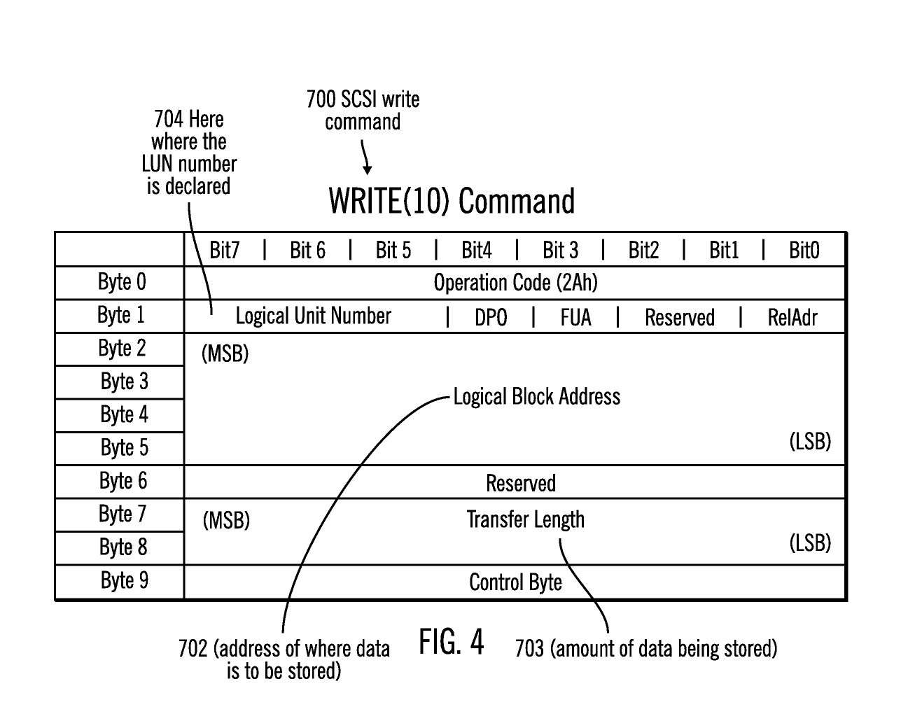

FIG. 4 illustrates an example write command used in accordance with certain embodiments. A write command 700 may be used to store data to the multi-format data store 170. Write command 700 is an example of a SCSI write command, comprising a starting logical block address (LBA) 702, transfer length 703, and Logical Unit Number (LUN) 704. LUN 704 designates the layer of the multi-format data store 170 to which write command 700 is directed. Starting LBA 702 indicates the first logical block address on the destination multi-format data store 170 to receive data, and transfer length 703 indicates how much data is transferred. Write command 700 may be implemented across a SCSI or Fibre Channel interface. Write command 700 is one possible write command which may be used by embodiments. Other write commands are within the scope of embodiments. For example, SCSI write commands that include write plus verify, where the written data is verified before the write command successfully concludes, may be used with embodiments.

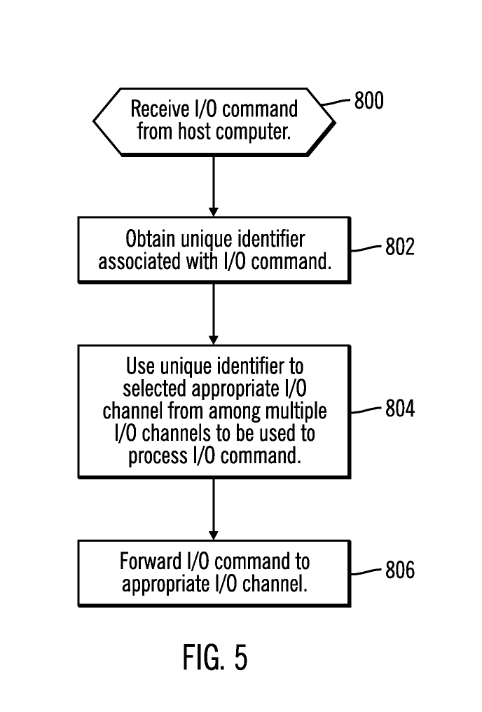

FIG. 5 illustrates logic performed by the data store device 120 in accordance with certain embodiments. Control begins at block 800 with the data store device 120 receiving an I/O command from the host computer 100. Although not shown, there may be various communications between the host computer 100 and the data store device 120 before the actual I/O command is transmitted from the host computer 100 to the data store device 120.

In the case of a SCSI-based protocol, I/O commands are initiated by host computers (e.g., 100), and the host computers are referred to as initiators. Initiators send I/O commands to targets, which in this case is a data store device 120.

The host computer 100 sends a Command Descriptor Block (CDB) within a command information unit, which contains from 6 to 16 bytes of information, including the Logical Unit Number (LUN), the command to be executed, any relevant parameters associated with the command, and an identifying hexidecimal queue tag. The queue tag is a label that is used by the data store device 120 and host computer 100 to distinguish a particular transaction from all others, so that all transactions that are active at any instant will have different tags, and all pieces of any single transaction will have the same queue tag. Thus, the data from a particular write command can be associated with that write command using the queue tag. The data store device 120 device receives the CDB and passes it to the appropriate logical unit number. The logical unit then examines the command and determines if it is valid and executable. If it is invalid or cannot be executed by the LUN, then an appropriate status code is sent to the host computer 100 indicating the reason that the command cannot be executed, otherwise, the command is executed. If the I/O command is a read-type command such that data is transferred from the data store device 120 to the host computer 100, then the data store device 120 fetches the data requested, beginning at the logical block address requested in the CDB, and reads as many subsequent sequential blocks as have been requested, again from within the CDB. If the I/O command is a write-type command, where the data flows from the host computer 100 to the data store device 120, then the data store device 120 requests the data in chunks that are of a manageable size by the data store device 120's definition, until all data to be written has been transferred. When all the data has been sent, the data store device 120 then sends a status information unit indicating whether the command was successfully executed from the data store device 120 viewpoint.

In block 802, the data store device 120 obtains a unique identifier (e.g., a LUN) associated with the I/O command. In certain embodiments, the unique identifier is part of the I/O command (e.g., write command 700). The unique identifier may be described as identifying the region of the multi-format data store 170 to which the I/O command is directed. The unique identifier is associated with both a specific I/O channel 132 . . . 136 and with a particular data format 172 . . . 176. In block 804, the data store device 120 uses the unique identifier to select an appropriate I/O channel from multiple I/O channels to be used to process I/O command. In block 806, the data store device 120 forwards the I/O command to the appropriate I/O channel 132 . . . 136.

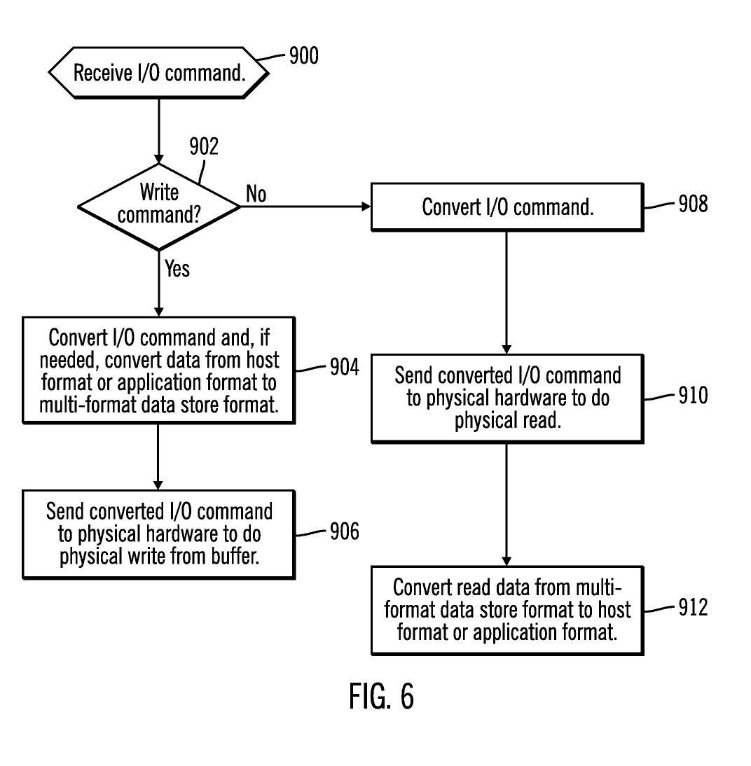

FIG. 6 illustrates logic performed by an I/O channel 132 . . . 136 in accordance with certain embodiments. In block 900, the I/O channel 132 . . . 136 receives an I/O command from the data store device 120. In block 902, the I/O channel 132 . . . 136 determines whether a write command has been received. If a write command has been received, processing continues to block 904, otherwise, processing continues to block 908. In block 904, the I/O channel 132 . . . 136 converts the I/O command to a format understood by physical hardware and, if needed, converts data from a host format or application format to a multi-format data store format. Such conversion may also be referred to as migration. In certain embodiments, the conversions may involve sector header information and sector length. A sector may be described as the smallest building block of storage, which is typically 512 bytes of data in size for hard disk drives and typically 2048 bytes for optical disk drives. These sectors (also referred to as building blocks) are aggregated to hold the files stored. In block 906, the I/O channel 132 . . . 136 sends the converted I/O command to the physical hardware to do a physical write (i.e., record data) from a buffer (e.g., buffer element 591, 592 or 593).

In block 908, the I/O channel 132 . . . 136 converts the I/O command to a format understood by physical hardware. In block 910, the I/O channel 132 . . . 136 sends the converted I/O command to the physical hardware to do a physical read. In block 912, the I/O channel 132 . . . 136 converts read data from multi-format data store format to host format or application format.

Embodiments contribute to virtualization techniques. Virtualization refers to the fact that some underlying hardware is virtualized by a virtualization layer, in order to allow more functionality. Embodiments virtualize multiple virtual drives in one data store device 120 (e.g., a physical optical-drive) and a multi-format data store 170 (e.g., one physical piece of optical-media with multiple media types on distinctly different layers of the optical-media) by assigning unique properties to each virtual drive. The properties applied here are related to the incompatible layer types which are addressed by this virtual drive on incompatible and different layers of the same optical media. That is, not only are the media layers physically incompatible (e.g., Blu-ray is close to the surface of the optical disc, approximately 0.1 mm, while HD-DVD and DVD are 0.6 mm distant from the surface of the optical disc), but the recording formats differ between Blu-ray and HD-DVD/DVD.

Embodiments enable data migration from one optical technology to another, in a more cost-efficient manner because a customer does not have to purchase a complete new storage library in order to migrate old data from CD or DVD to a multi-format data store 170. With embodiments, the customer is able to purchase data store device 120 and multi-format data store 170 and utilize these in the existing storage library. Since the data store device 120 is able to read CD and DVD, the migration from CD to the multi-format data store 170 is simple and does not require an additional storage library. Hence, embodiments contribute to investment protection for customers with storage libraries. With migration, data is read from an old format media, and converted to a modern format media, such as reading an old Microsoft® Word document in an obsolete format and converting that document to the latest-version format.

Embodiments allow simultaneous access to the LUNs pertaining to one data store device 120 because each LUN reads and writes to a different physical layer. Each LUN is capable of buffering write data if an accessor, of a storage library that loads a multi-format data store 170 into the data store device 120, is not available at the moment. In alternative embodiments, a SCSI architecture may be used that allows the LUN to present a BUSY status to an I/O command that was received on one LUN in case the data store device 120 is too busy and the buffer for the LUN reaches a critical limit.

In certain embodiments, the Blu-ray layer may appear as a D: device to a host computer with a Windows® operating system, while the DVD layer may appear as an E: device, and the CD layer as an F: device. The I/O channel and capacities vary widely between these optical technologies, hence, by independently identifying them to the user, the user may find it easier to store and retrieve data. Similarly, the individual layers may be represented by different destination GUI icons, and the user may then drag and drop icons of data files to those GUI icons for appropriate storage in the format that the GUI icon represents (such as a DVD GUI icon, a Blu-Ray GUI icon, etc.).

In certain alternate embodiments, the data store device 120 is a tape drive, and the multi-format data store 170 is a Linear Tape Open (LTO) tape cartridge is used to support multiple tape formats used by the host or host applications. In such embodiments, the LTO tape cartridge may be described as having one or more partitions, with each partition being associated with a data format. LTO, 3480, 3490, 3590 and 3592 may each be described as a magnetic tape data format. Historically, LTO, 3480, 3490, 3590 and 3592 have also had unique physical tape cartridges. To get around having a different tape cartridge for every tape format, for example, the LTO data format itself may be associated with LUN-0, 3480 emulation data format may be associated with LUN-2, 3490 emulation data format may be associated with LUN-3, 3590 emulation data format may be associated with LUN-4, 3592 emulation data format may be associated with LUN-5. The emulation data formats refer to data formats used by applications at the host computer 100, for storing data using a common format on the tape. This is the opposite technique as was described for the optical disk 470. In the optical description, a multiple laser head assembly 200 could independently access layers 410, 412, 413 and their different formats. In tape, a common format is preferred for storing the data on the tape itself, but the host interface is multi-lingual and can receive application generated data of different formats and convert it to a common format for storage on the tape. Embodiments do not require any partitioning of the tape. In certain embodiments, partitioning could be used to further augment the grouping of host data or host application data of different formats, namely one partition only involves LUN-0, and the next partition only involves LUN-1, etc.

In this manner, embodiments may be used to phase out old tape drives with new ones, while not disturbing legacy customer applications. These alternate embodiments permit newer and more reliable tape drives to replace older ones, while being transparent to applications. In such embodiments, the tape drive is capable of translating the data between the multiple host formats and the single tape cartridge format based on a unique identifier (e.g., a chosen LUN). With this multiple emulation embodiment, the tape drive is multi-lingual to the host computer, while having just one data-storage format to the tape itself. In certain additional embodiments, the data is stored in the same format as supplied by the host computer, but the tape drive knows in what format to convert the read data, based on the LUN specified by the host computer, to the desired host format or application format. For example, MACs and PCs use different host formats, even though they may be using the same application. Also, a PC may be running several applications, each of which requires a different application format.

In certain embodiments, different host computers or different host applications on the same computer are associated with different unique identifiers (i.e., different regions of the multi-storage data store 170 or different LUNs). In other embodiments, the tape is partitioned either along its length or in sets of tracks along its width to support different formats on the same tape. In this case, each partition is accessed via a different LUN.

Thus, embodiments teach that each of the different data formats supported by a multi-format data store 170 are accessed by a separate unique identifier, such as a Logical Unit Number (LUN). Embodiments provide a single physical data store device 120 that supports multiple recording data formats in physically different regions of the same multi-format data store 170 (e.g., optical media) and uses separate unique identifiers (e.g., LUNs) to access each data format in each physically different region of the multi-format data store 170.

Windows is a registered trademark of Microsoft Corporation in the United States and/or other countries.

### Additional Embodiment Details

The described operations may be implemented as a method, computer program product or apparatus using standard programming and/or engineering techniques to produce software, firmware, hardware, or any combination thereof. Each of the embodiments may take the form of an entirely hardware embodiment, an entirely software embodiment or an embodiment containing both hardware and software elements. The embodiments may be implemented in software, which includes but is not limited to firmware, resident software, microcode, etc.

Furthermore, the embodiments may take the form of a computer program product accessible from a computer-usable or computer-readable medium providing program code for use by or in connection with a computer or any instruction execution system. For the purposes of this description, a computer-usable or computer readable medium may be any apparatus that may contain, store, communicate, propagate, or transport the program for use by or in connection with the instruction execution system, apparatus, or device.

The described operations may be implemented as code maintained in a computer-usable or computer readable medium, where a processor may read and execute the code from the computer readable medium. The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a rigid magnetic disk, an optical disk, magnetic storage medium (e.g., hard disk drives, floppy disks, tape, etc.), volatile and non-volatile memory devices, such as a random access memory (RAM), DRAMs, SRAMs, a read-only memory (ROM), programmable ROMs (PROMs), electrically erasable PROMs (EEPROMs), Flash Memory, firmware, programmable logic, etc. Current examples of optical disks include compact disk-read only memory (CD-ROM), compact disk-read/write (CD-R/W), and Digital Versatile Disk (DVD), high-definition DVD (HD-DVD), Blu-Ray, and holography. Current examples of tape include magnetic tape and optical tape.

The code implementing the described operations may further be implemented in hardware logic (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices.

A computer program product may comprise computer useable or computer readable media, hardware logic, and/or transmission signals in which code may be implemented. Of course, those skilled in the art will recognize that many modifications may be made to this configuration without departing from the scope of the embodiments, and that the computer program product may comprise any suitable information bearing medium known in the art.

The term logic may include, by way of example, software, hardware, firmware, and/or combinations of software and hardware.

Certain embodiments may be directed to a method for deploying computing infrastructure by a person or automated processing integrating computer-readable code into a computing system, wherein the code in combination with the computing system is enabled to perform the operations of the described embodiments.

The logic of FIGS. 5 and 6 describes specific operations occurring in a particular order. In alternative embodiments, certain of the logic operations may be performed in a different order, modified or removed. Moreover, operations may be added to the above described logic and still conform to the described embodiments. Further, operations described herein may occur sequentially or certain operations may be processed in parallel, or operations described as performed by a single process may be performed by distributed processes.

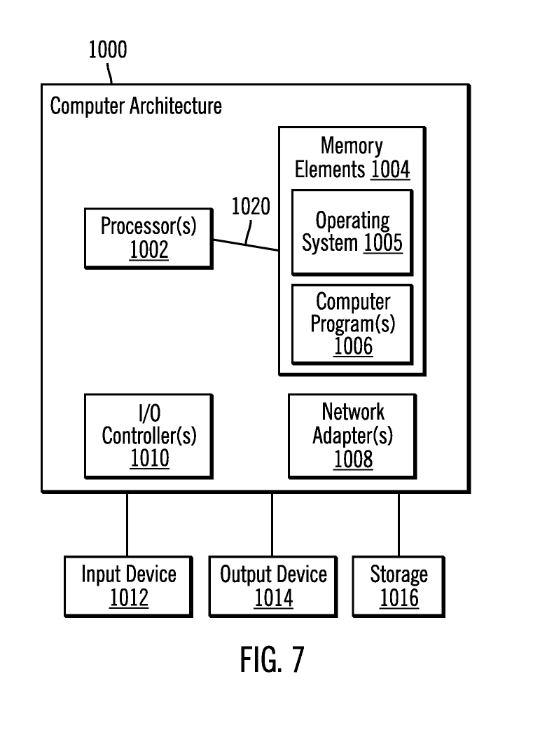

The illustrated logic of FIGS. 7 and 8 may be implemented in software, hardware, programmable and non-programmable gate array logic or in some combination of hardware, software, or gate array logic.

FIG. 7 illustrates a system architecture 1000 that may be used in accordance with certain embodiments. Host computer 100 and/or data storage drive 120 may implement system architecture 1000. The system architecture 1000 is suitable for storing and/or executing program code and includes at least one processor 1002 coupled directly or indirectly to memory elements 1004 through a system bus 1020. The memory elements 1004 may include local memory employed during actual execution of the program code, bulk storage, and cache memories which provide temporary storage of at least some program code in order to reduce the number of times code must be retrieved from bulk storage during execution. The memory elements 1004 include an operating system 1005 and one or more computer programs 1006. Computer programs 1006 may be called applications, such as applications 110 shown in FIG. 1.

Input/Output (I/O) devices 1012, 1014 (including but not limited to user-interfaces such as keyboards, displays, pointing devices, etc.) may be coupled to the system either directly or through intervening I/O controllers 1010.

Network adapters 1008 may also be coupled to the system to enable the data processing system to become coupled to other data processing systems or remote printers or storage devices through intervening private or public networks. Modems, cable modem and Ethernet cards are just a few of the currently available types of network adapters 1008.

The system architecture 1000 may be coupled to storage 1016 (e.g., a non-volatile storage area, such as magnetic disk drives, optical disk drives, a tape drive, etc.), such as data store device 120. The storage 1016 may comprise an internal storage device or an attached or network accessible storage. Computer programs 1006 in storage 1016 may be loaded into the memory elements 1004 and executed by a processor 1002 in a manner known in the art.

The system architecture 1000 may include fewer components than illustrated, additional components not illustrated herein, or some combination of the components illustrated and additional components. The system architecture 1000 may comprise any computing device known in the art, such as a mainframe, server, personal computer, workstation, laptop, handheld computer, telephony device, network appliance, virtualization device, storage controller, etc.

The foregoing description of embodiments of the invention has been presented for the purposes of illustration and description. It is not intended to be exhaustive or to limit the embodiments to the precise form disclosed. Many modifications and variations are possible in light of the above teaching. It is intended that the scope of the embodiments be limited not by this detailed description, but rather by the claims appended hereto. The above specification, examples and data provide a complete description of the manufacture and use of the composition of the embodiments. Since many embodiments may be made without departing from the spirit and scope of the embodiments, the embodiments reside in the claims hereinafter appended or any subsequently-filed claims, and their equivalents.

What is claimed is:

1. A computer-implemented method for storing data, comprising:
receiving an Input/Output (I/O) command, wherein the I/O command includes a unique identifier that is associated with one region of a multi-format data store;
using the unique identifier to select an I/O channel from among multiple I/O channels, wherein each I/O channel is associated with a data format and with a region of the multi-format data store; and
forwarding the I/O command to the selected I/O channel to access the region.

2. The method of claim 1, wherein the unique identifier comprises a Logical Unit Number.

3. The method of claim 1, wherein the multi-format data store comprises an optical disk, and the one region comprises a particular depth of the optical disk.

4. The method of claim 1, wherein the I/O command is a write command and further comprising:
converting data in the I/O command from one of a host format and an application format to a multi-format data store format; and
recording the converted data in the one region of the multi-format data store associated with the selected I/O channel.

5. The method of claim 1, wherein the I/O command is a read command and further comprising:
converting read data from a multi-format data store format to one of a host format and an application format.

6. The method of claim 1, wherein the multi-format data store is capable of storing data in at least two of: a compact disk (CD) format, a Digital Video Disk (DVD) format, a Blu-ray format, and a High Definition (HD) DVD format.

7. The method of claim 1, wherein multiple virtual drives access the multi-format data store and wherein each of the multiple virtual drives is associated with a different data format.

8. The method of claim 1, wherein the multi-format data store comprises a data store device.

9. The method of claim 1, wherein the multi-format data store comprises a Linear Tape Open (LTO) tape cartridge, and wherein the one region is a partition of the LTO tape cartridge.

10. The method of claim 9, wherein there are multiple host formats and a single tape cartridge format, and wherein data is translated from one of the host formats to the single tape cartridge format based on the unique identifier.

11. The method of claim 1, wherein each I/O channel is capable of encoding and decoding data and is associated with one or more lasers and wherein each laser is associated with a data format.

12. A computer program product comprising a computer useable medium including a computer readable program, wherein the computer readable program when executed on a computer causes the computer to:
receive an Input/Output (I/O) command, wherein the I/O command includes a unique identifier that is associated with one region of a multi-format data store;
use the unique identifier to select an I/O channel from among multiple I/O channels, wherein each I/O channel is associated with a data format and with a region of the multi-format data store; and
forward the I/O command to the selected I/O channel to access the region.

13. The computer program product of claim 12, wherein the unique identifier comprises a Logical Unit Number.

14. The computer program product of claim 12, wherein the multi-format data store comprises an optical disk, and the one region comprises a particular depth of the optical disk.

15. The computer program product of claim 12, wherein the I/O command is a write command and wherein the computer readable program when executed on a computer causes the computer to:
convert data in the I/O command from one of a host format and an application format to multi-format data store format; and
record the converted data in the one region of the multi-format data store associated with the selected I/O channel.

16. The computer program product of claim 12, wherein the I/O command is a read command and wherein the computer readable program when executed on a computer causes the computer to:
convert read data from a multi-format data store format to one of a host format and an application format.

17. The computer program product of claim 12, wherein the multi-format data store is capable of storing data in at least two of: a compact disk (CD) format, a Digital Video Disk (DVD) format, a Blu-ray format, and a High Definition (HD) DVD format.

18. The computer program product of claim 12, wherein multiple virtual drives access the multi-format data store and wherein each of the multiple virtual drives is associated with a different data format.

19. The computer program product of claim 12, wherein the multi-format data store comprises a data store device.

20. The computer program product of claim 12, wherein the multi-format data store comprises a Linear Tape Open (LTO) tape cartridge, and wherein the one region is a partition of the LTO tape cartridge.

21. The computer program product of claim 20, wherein there are multiple host formats and a single tape cartridge format, and wherein data is translated from one of the host formats to the single tape cartridge format based on the unique identifier.

22. The computer program product of claim 12, wherein each I/O channel is capable of encoding and decoding data and is associated with one or more lasers and wherein each laser is associated with a data format.

23. A system for storing data, comprising:
a multi-format data store that is capable of storing data in different formats;
a data storage drive including two or more Input/Output (I/O) channels and coupled to the multi-format data store; and
hardware logic at the data storage drive capable of performing operations, the operations comprising:
receiving an Input/Output (I/O) command, wherein the I/O command includes a unique identifier that is associated with one region of the multi-format data store;
using the unique identifier to select an I/O channel from among multiple I/O channels, wherein each I/O channel is associated with a data format and with a region of the multi-format data store; and
forwarding the I/O command to the selected I/O channel to access the region.

24. The system of claim 23, wherein the unique identifier comprises a Logical Unit Number.

25. The system of claim 23, wherein the multi-format data store comprises an optical disk, and the one region comprises a particular depth of the optical disk.

26. The system of claim 23, wherein the I/O command is a write command and wherein each of the I/O channels is capable of converting data in the I/O command from one of a host format and an application format to a multi-format data store format and recording the converted data in the one region of the multi-format data store associated with the selected I/O channel.

27. The system of claim 23, wherein the I/O command is a read command and wherein each of the I/O channels is capable of converting read data from a multi-format data store format to one of a host format and an application format.

28. The system of claim 23, wherein the multi-format data store is capable of storing data in at least two of: a compact disk (CD) format, a Digital Video Disk (DVD) format, a Blu-ray format, and a High Definition (HD) DVD format.

29. The system of claim 23, wherein multiple virtual drives access the multi-format data store and wherein each of the multiple virtual drives is associated with a different data format.

30. The system of claim 23, wherein the multi-format data store comprises a data store device.

31. The system of claim 23, wherein the multi-format data store comprises a Linear Tape Open (LTO) tape cartridge, and wherein the one region is a partition of the LTO tape cartridge.

32. The system of claim 31, wherein there are multiple host formats and a single tape cartridge format, wherein the data storage drive comprises a tape drive, and wherein the tape drive is capable of translating from one of the host formats to the single tape cartridge format based on the unique identifier.

33. The system of claim 23, wherein each I/O channel is capable of encoding and decoding data and is associated with one or more lasers and wherein each laser is associated with a data format.

34. A method for providing a service, the service comprising:
receiving an Input/Output (I/O) command, wherein the I/O command includes a unique identifier that is associated with one region of a multi-format data store and wherein the one region is associated with a multi-format data store format;
in response to determining that the I/O command is a write command,
converting data in the I/O command from one of a host format and an application format to the multi-format data store format; and
recording the converted data in the one region of the multi-format data store; and
in response to determining that the I/O command is a read command,
reading data from the one region of the multi-format data store; and
converting the read data from a multi-format data store format to one of the host format and the application format.

35. The method of claim 34, further comprising:
using the unique identifier to select an I/O channel from among multiple I/O channels, wherein each I/O channel is associated with a data format and with a region of the multi-format data store; and
forwarding the I/O command to the selected I/O channel to access the region.
